(19) United States
(12) Patent Application Publication
(10) Pub. No.: US 2006/0127564 A1
(43) Pub. Date: Jun. 15, 2006

(54) Electric wire formation method, wiring substrate manufacturing method, electrooptical element manufacturing method, electronic apparatus manufacturing method, wiring substrate, electrooptical element, and electronic apparatus

(75) Inventors: Naoyuki Toyoda, Suwa (JP); Toshimitsu Hirai, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/299,336

(22) Filed: Dec. 9, 2005

(30) Foreign Application Priority Data
Dec. 10, 2004 (JP) 2004-357716

(51) Int. Cl. B05D 5/12

(52) U.S. Cl. 427/58

(57) ABSTRACT

A method for forming electric wire by disposing a functional liquid by using a droplet ejection apparatus, including: forming on a substrate a partition wall defining a groove in a manner that a surface of the substrate becomes a bottom part of the groove; forming on the bottom part a lyophilic layer having a higher lyophilic property against a first functional liquid than a lyophilic property of the partition wall against the first functional liquid; and disposing on the lyophilic layer the first functional liquid containing metal by using a droplet ejection apparatus.

### BACKGROUND

1. Technical Field

The present invention relates to an electric wire formation method and, in particular, to an electric wire formation method suitable for application of an inkjet method.

2. Related Art

As a technique used for forming electric wires by an inkjet method using a droplet ejection apparatus, a technique disclosed in JP-A-2000-311527 is known. With this technique, a pattern is formed by applying ink containing an electroless plating catalyst on an ink receptive layer, and, thereafter, a conductive metal is formed on this pattern by an electroless plating method.

In recent years, in order to form minuter wires, a technique has been developed, in which a partition wall called a bank pattern is formed in a manner that wires fringe a pattern to be disposed, and metal ink is applied to a groove shaped by this bank pattern and a substrate surface so as to form the electric wires. According to this technique, it is possible to form the wires minuter than those formed without using the bank pattern, since the width of the wires is determined by the interval of the bank pattern.

In this case, in order to form the electric wires having an even thickness, it is necessary to evenly spread the metal ink applied to the bottom part of the above-referenced groove. For this purpose, the bottom part is made relatively more highly lyophilic to the metal ink than the bank pattern is to the metal ink, by using a material for the bank pattern having liquid repellency to the metal ink and by subjecting the bank pattern to plasma processing so as to impart liquid repellency to the pattern surface against the metal ink.

However, in this method, there is a problem that, if residues remain at the bottom part of the groove when patterning the bank pattern, the lyophilic property of the bottom part cannot be relatively high to the bank pattern, and the metal ink does not spread evenly at the bottom part.

### SUMMARY

An advantage of the invention is to provide an electric wire forming method, with which it is possible to apply a uniformly and evenly thick metal ink to the bottom part by imparting liquid repellency to the partition wall and, at the same time, by imparting reliable lyophilic property to the bottom part of the groove.

According to an aspect of the invention, an electric wire formation method using a droplet ejection apparatus includes: forming on a substrate a partition wall defining a groove in a manner that a surface of the substrate becomes a bottom part of the groove; forming on the bottom part a lyophilic layer having a higher lyophilic property against a first functional liquid than a lyophilic property of the partition wall against the first functional liquid; and disposing on the lyophilic layer the first functional liquid containing metal by using a droplet ejection apparatus.

One of the effects produced by this structure is that a conductive material can be formed to have a uniform and even thickness.

Preferably, in the above-referenced structure, the lyophilic layer formation method may include forming the lyophilic layer by disposing a second functional liquid containing microparticles of silica on the bottom part. The second functional liquid may further contain microparticles of at least one selected from titanium oxide (TiO₂), zinc oxide (ZnO), tin oxide (SnO₂), strontium titanate (SrTi₃), tungsten oxide (WO₃), bismuth oxide (Bi₂O₃), and iron oxide (Fe₂O₃).

Further, the lyophilic layer formation process may further include forming the lyophilic layer on the bottom part by disposing the second functional liquid containing microparticles composed of a combination of at least two selected from silica, titanium oxide, zinc oxide, tin oxide, strontium titanate, tungsten oxide, bismuth oxide, and iron oxide. Alternatively, the lyophilic layer formation process may include forming the lyophilic layer on the bottom part by disposing the second functional liquid containing microparticles composed of a combination of silica with at least two selected from titanium oxide, zinc oxide, tin oxide, strontium titanate, tungsten oxide, bismuth oxide, and iron oxide.

One of the effects produced by this structure is that the lyophilic layer acquires lyophilic property against the conductive material.

Further, it is preferable that an average diameter of the microparticle is 1 μm or less.

One of the effects produced by fulfilling this condition is that, when ejecting the functional liquid using the droplet ejection apparatus, the functional liquid can be ejected in a desired direction without getting clogged.

Also, the partition wall formation process may include forming the partition wall using a photoresist mixed with a fluorine-containing polymer compound or with a fluorine-containing organic molecule.

One of the effects produced by this structure is that the effect of the invention, in that the conductive material can be formed to have the uniform and even thickness, can be enhanced.

According to another aspect of the invention, an electric wire formation method using a droplet ejection apparatus includes: forming on a substrate a lyophilic layer having a higher lyophilic property against a first functional liquid than a lyophilic property of a partition wall against the first functional liquid; forming on the lyophilic layer the partition wall defining a groove in a manner that the lyophilic layer becomes a bottom part of the groove; and disposing on the bottom part the first functional liquid containing metal by using a droplet ejection apparatus.

One of the effects produced by this structure is that the conductive material can be formed to have the uniform and even thickness.

It is preferable that the lyophilic layer formation process includes forming the lyophilic layer by disposing a second functional liquid containing microparticles of silica on the bottom part. The second functional liquid may further contain microparticles of at least one selected from titanium oxide (TiO₂), zinc oxide (ZnO), tin oxide (SnO₂), strontium titanate (SrTi₃), tungsten oxide (WO₃), bismuth oxide (Bi₂O₃), and iron oxide (Fe₂O₃).

Further, the lyophilic layer formation process may further include forming the lyophilic layer on the bottom part by disposing the second functional liquid containing microparticles composed of a combination of at least two selected from silica, titanium oxide, zinc oxide, tin oxide, strontium titanate, tungsten oxide, bismuth oxide, and iron oxide. Alternatively, the lyophilic layer formation process may further include forming the lyophilic layer on the bottom part by disposing a second functional liquid containing microparticles composed of a combination of silica with at least two selected from titanium oxide, zinc oxide, tin oxide, strontium titanate, tungsten oxide, bismuth oxide, and iron oxide.

One of the effects produced by this structure is that the lyophilic layer acquires lyophilic property against the conductive material.

Further, it is preferable that an average diameter of the microparticle is 1 μm or less.

One of the effects produced by fulfiling this condition is that, when ejecting the functional liquid using the droplet ejection apparatus, the functional liquid can be ejected in a desired direction without getting clogged.

Furthermore, the partition wall formation process may include forming the partition wall using a photoresist mixed with a fluorine-containing polymer compound or with a fluorine-containing organic molecule.

One of the effects produced by this structure is that the effect of the invention, in that the conductive material can be formed to have the uniform and even thickness, can be enhanced.

One mode of the invention may include irradiating the lyophilic layer with light. In this case, it is preferable that the wavelength of the light is 400 nm or less.

One of the effects produced by this structure is that the lyophilic property of the lyophilic layer against the conductive material is enhanced.

In another mode of the invention, the partition wall may include a fluorine-containing organic molecule.

One of the effects produced by this structure is that the partition wall acquires liquid repellency against the conductive material.

Yet another mode of the invention may include subjecting the partition wall surface to plasma processing by using a fluorocarbon compound as a reactant gas.

One of the effects produced by this structure is that the liquid repellency of the partition wall to the conductive material improves further.

Additionally, the invention can be realized in various modes. More specifically, the invention can be realized as a wiring substrate manufacturing method, an electrooptical element manufacturing method, or an electronic apparatus manufacturing method. Further, the wiring substrate manufactured by the wiring substrate formation method of the invention has uniformly and evenly thick electric wires. Since an electrooptical element and an electronic apparatus equipped with this wiring substrate have the uniformly and evenly thick electric wires, the electrooptical element and electronic apparatus can have good electric characteristics.

### BRIEF DESCRIPTION OF THE DRAWINGS

The invention will be described with reference to the accompanying drawings, wherein like numbers reference like elements.

FIG. 1 is a pattern diagram showing a structure of a wire substrate.

FIG. 2 is a pattern diagram showing an apparatus for manufacturing electric wires.

FIG. 3 is a pattern diagram showing a droplet ejection apparatus.

FIGS. 4A and 4B are pattern diagrams showing a head of the droplet ejection apparatus.

FIG. 5 is a functional block diagram of a control section of the droplet ejection apparatus.

FIGS. 6A through 6D are diagrams to explain an electric wire formation method of a first embodiment.

FIGS. 7A and 7B are diagrams to explain the electric wire formation method of the first embodiment.

FIG. 8 is a pattern diagram showing a liquid crystal display device of the first embodiment.

FIG. 9 is a pattern diagram showing a cellular phone of the first embodiment.

FIG. 10 is a pattern diagram showing a personal computer of the first embodiment.

FIGS. 11A through 11D are diagrams to explain the electric wire formation method of a second embodiment.

FIG. 12 is a diagram to explain the electric wire formation method of the second embodiment.

FIGS. 13A and 13B are diagrams to explain the electric wire formation method of a third embodiment.

### DESCRIPTION OF EXEMPLARY EMBODIMENTS

Embodiments of the invention will now be described with reference to the drawings.

### First Embodiment

Wiring Substrate

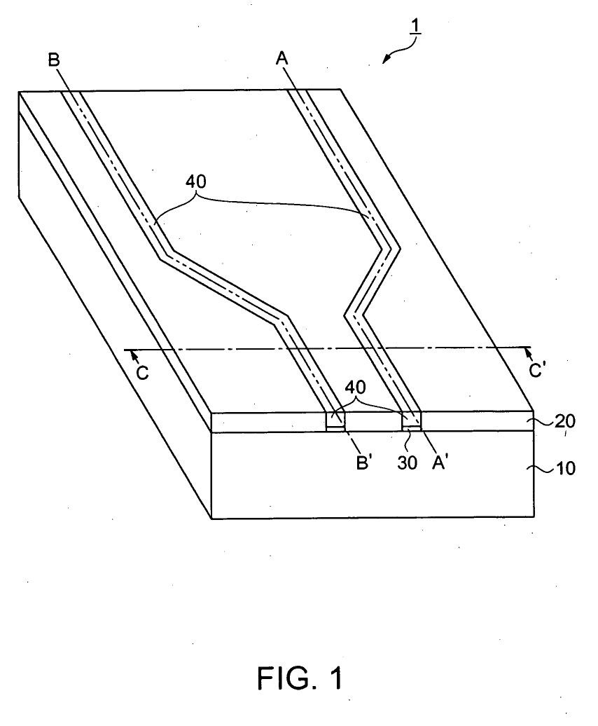

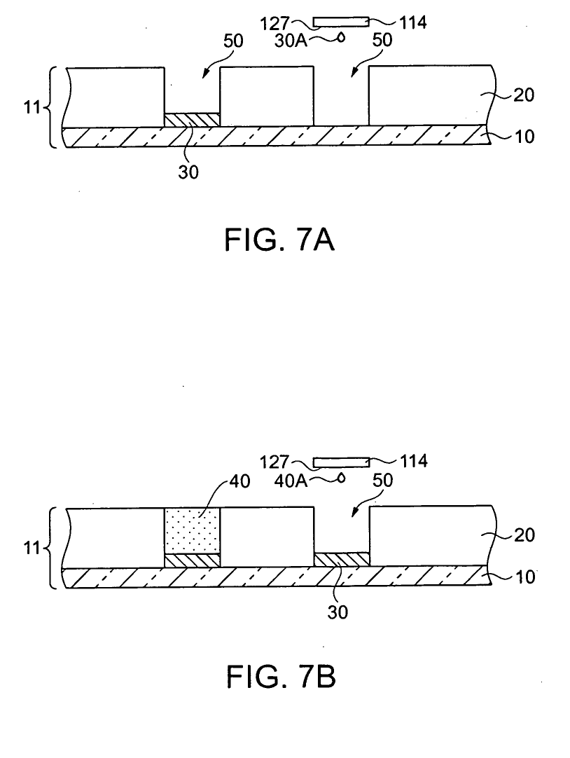

FIG. 1 is a perspective diagram of a wiring substrate 1 having electric wires formed by the electric wire formation method of the present embodiment. An X-Z plane located on a line C-C′ in FIG. 1 corresponds to a plane shown in FIG. 7B.

The wiring substrate 1 includes a support substrate 10 composed of polyimide, a bank pattern 20, a lyophilic layer 30, and a conductive layer 40. Here, both the bank pattern 20 and the lyophilic layer 30 are located on the support substrate 10. Further, the conductive layer 40 is located on the lyophilic layer 30. The bank pattern 20 is formed by processing an organic thin film composed of fluorine-containing organic molecules. More specifically, as the organic molecules, CF₃CF₂CF₂CF₂CF₂CF₂CF₂CF₂CH₂CH₂—Si(OCH₃)₃ which is a kind of a silane coupling agent is used. The bank pattern 20 containing such a material has liquid repellency against a hereinafter-described conductive material 40A (FIG. 7B). Further, the support substrate 10 corresponds to the “substrate” in the invention, while the bank pattern 20 corresponds to the “partition wall” in the invention.

The lyophilic layer 30 and the conductive layer 40, in this order, are filled from the surface side of the support substrate 10 in a groove partitioned by the bank pattern 20.

The lyophilic layer 30 is made from a lyophilic material 30A (FIG. 7A) containing microparticles composed of silica (SiO₂) and titanium oxide (TiO₂) and has the lyophilic property against the hereinafter-described conductive material 40A. In addition, since the lyophilic layer 30 contains the microparticles of titanium oxide (TiO₂), when it is irradiated with light having the wavelength of 400 nm or less, the lyophilic property can be further improved by the photocatalytic reaction. Thus, the lyophilic property of the lyophilic layer 30 to the conductive material 40A (FIG. 7B) is set to be higher than the lyophilic property of the bank pattern 20 to the conductive material 40A. Examples of the lyophilic material 30A dispersed in a titanium oxide dispersant are: a hydrochloric acid peptizing-type, anatase-type titania sol (STS-02 manufactured by Ishihara Sangyo Kaisha, Ltd., with the average particle diameter of 7 nm) and a nitric acid peptizing-type, anatase-type titania sol (TA-15 manufactured by Nissan Chemical Industries, Ltd., with the average particle diameter of 12 nm).

The conductive layer 40 is formed using the metal-containing conductive material 40A as its ingredient. The conductive material 40A is a metal microparticle dispersion that contains silver particles having the average diameter of about 10 nm and water as the dispersion medium. The silver particles are covered with polymer or surfactant in order to avoid aggregation. Because of this structure, the silver particles are stably dispersed in the dispersion medium of the conductive material 40A. It is preferable that the average diameter of the metal microparticles contained in the conductive material 40A is 500 nm or less. In particular, the microparticles having the average diameter of from about one nanometer to some hundred nanometers are expressed as “nanoparticles.” According to this expression, the conductive material 40A contains nanoparticles of silver. In addition, this conductive material 40A in liquid form is called “metallic ink.”

When the conductive material 40A is applied as a layer and either baked in high temperature or irradiated with light, fusion or welding takes place among the silver particles, and the conductive layer 40 which is a low resistance conductive matter is produced. The conductive layer 40 carries out an electric conduction at the wiring substrate 1, electrically conducting between A and A′ and B and B′ in FIG. 1.

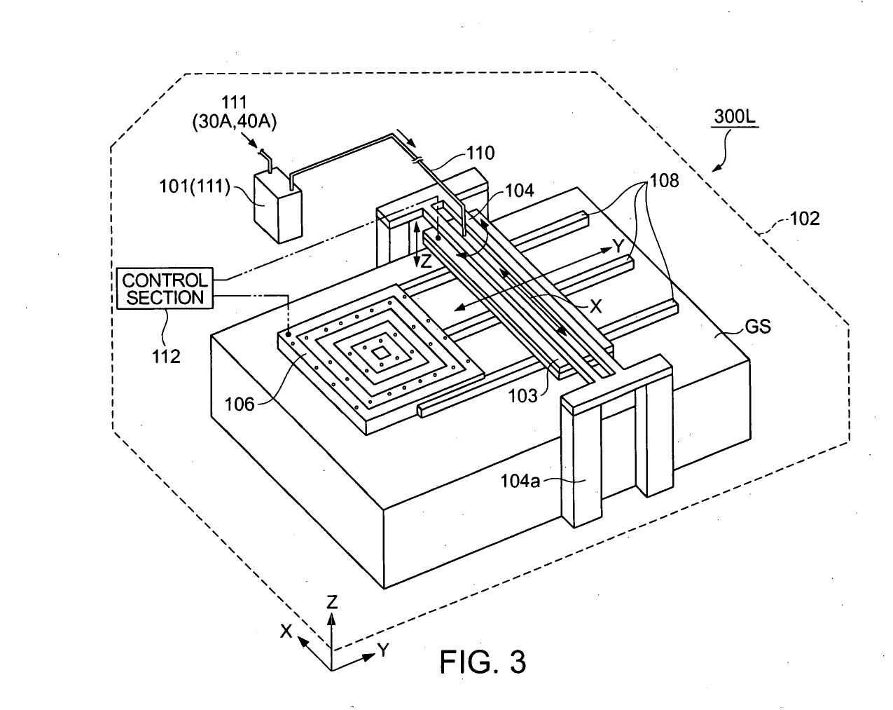

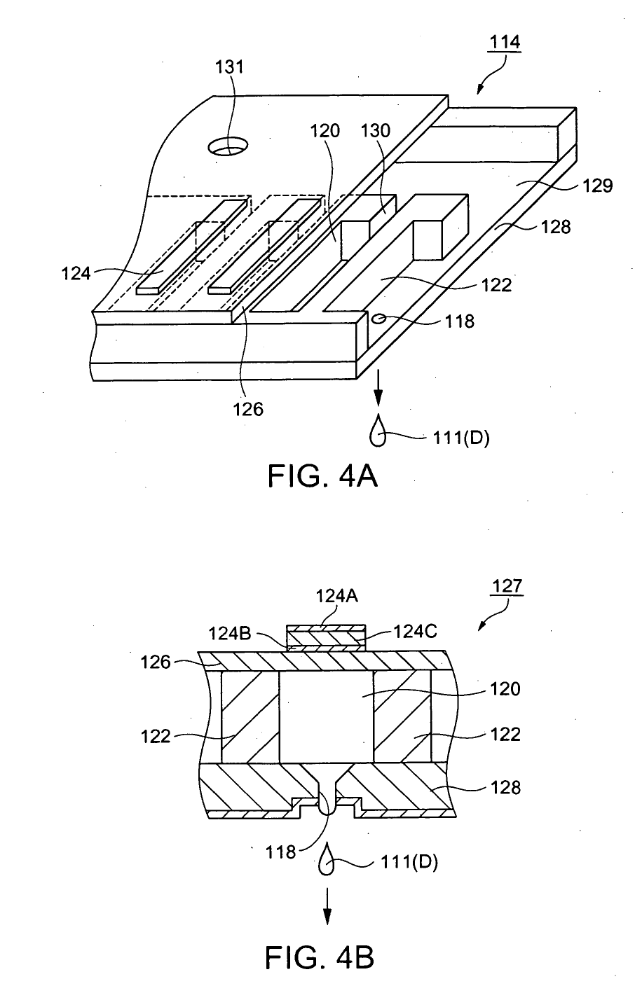

Additionally, the conductive material 40A corresponds to the “first functional liquid” in the invention, and the lyophilic material 30A (FIG. 7A) corresponds to the “second functional liquid” in the invention. The lyophilic material 30A and the conductive material 40A are both a type of a liquid material 111 (FIGS. 3 and 4) which will be described later.

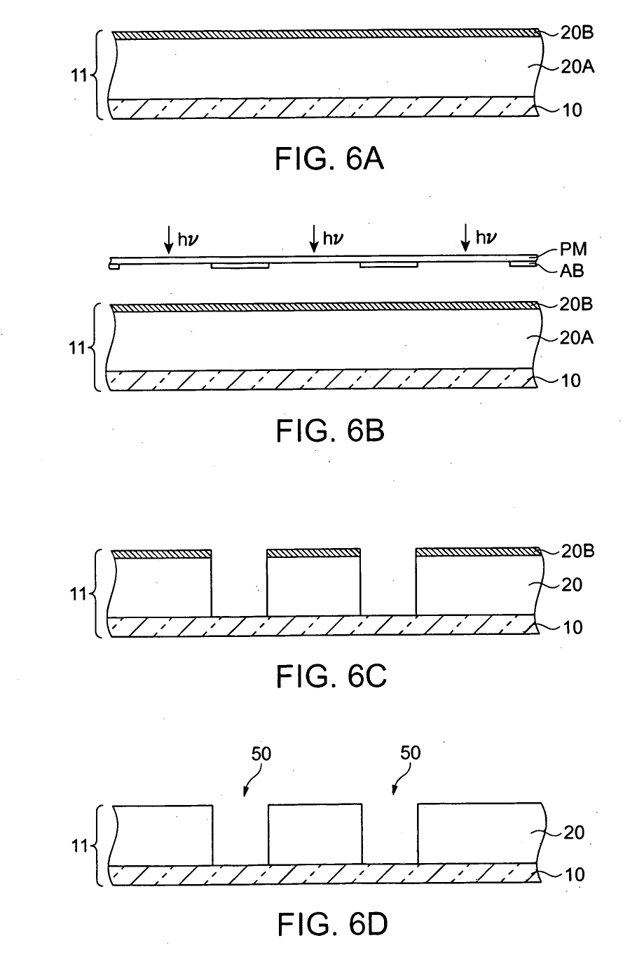

The groove partitioned by the bank pattern 20 will also be called a “landing portion 50 (FIG. 6D)” hereafter. The side surface of the landing portion 50 is defined by the bank pattern 20, and the bottom part thereof is defined either by the surface of the support substrate 10 or by the lyophilic layer 30. More specifically, the “landing portion 50” is a concept that includes both the groove whose side surface is the bank pattern 20 and whose bottom part is the support substrate 10, and the groove whose side surface is the bank pattern 20 and whose bottom part is the lyophilic layer 30.

It is to be noted that, in implementing the invention, the layout of the electric wires to be formed is not limited to the one shown in FIG. 1. The layout of the electric wires including the width, number, interval, configuration and the like of the wires can be freely modified depending on the purpose.

The bank pattern 20 of the embodiment has a plurality of apertures exposing the surface of the support substrate 10. The shape of each of the plurality of apertures approximately matches with the two-dimensional configuration of each of the plurality of electric wires (the conductive layer 40). In other words, in the embodiment, the bank pattern 20 is configured so as to completely surround the circumference of each of the plurality of electric wires that are formed later on.

Of course, the bank pattern 20 may be composed of a plurality of separate bank parts. For example, the two-dimensional configuration of one electric wire may be fringed between a pair of bank parts positioned approximately in parallel with each other. In this case, the bank parts do not have to be placed at portions corresponding to both ends of the electric wire. This means that the bank pattern 20 does not have to completely surround the two-dimensional circumference of the electric wire.

Manufacturing Equipment

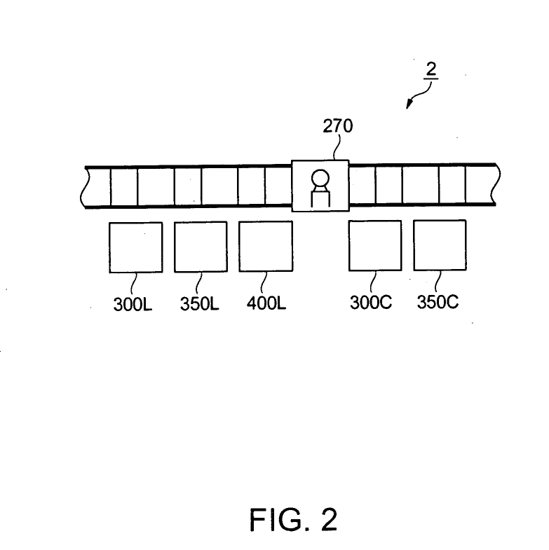

With reference to FIG. 2, a manufacturing equipment 2 used to manufacture the wiring substrate 1 will be described. In the following, the wiring substrate 1 before being provided with the conductive layer 40 is expressed as a substrate 11 (FIG. 6).

The manufacturing equipment 2 is an apparatus for forming the lyophilic layer 30 and the conductive layer 40 by disposing the lyophilic material 30A and the conductive material 40A at the landing portion 50 on the support substrate 10. The manufacturing equipment 2 is equipped with: a droplet ejection apparatus 300L that applies the lyophilic material 30A to the surface of the support substrate 10 composing all the bottom parts of the landing portions 50, a dryer 350L that dries the lyophilic material 30A on the surface of the support substrate 10 so as to obtain the lyophilic layer 30, a light irradiation apparatus 400L that irradiates light to the lyophilic layer 30, a droplet ejection apparatus 300C that applies the conductive material 40A to all of the lyophilic layers 30, and a dryer 350C that dries the conductive material 40A on the lyophilic layer 30 so as to form the conductive layer 40.

The manufacturing equipment 2 is further equipped with a transfer apparatus 270 that transfers the substrate 11 from the droplet ejection apparatus 300L to the dryer 350L, to the light irradiation apparatus 400L, to the droplet ejection apparatus 300C, and to the dryer 350C. Hence, the electric wire formation method of the embodiment utilizes two droplet ejection apparatuses.

Overall Structure of Droplet Ejection Apparatus

The droplet ejection apparatus 300L shown in FIG. 3 is basically an inkjet apparatus for ejecting the lyophilic material 30A. More specifically, the droplet ejection apparatus 300L is equipped with: a tank 101 that holds the liquid material 111, a tube 110, a grand stage GS, an ejection head section 103, a stage 106, a first position control unit 104, a second position control unit 108, a control section 112, and a support section 104a. The other droplet ejection apparatus 300C has basically the same structure and functions as those of the droplet ejection apparatus 300L. Accordingly, descriptions of the structure and functions of the droplet ejection apparatus 300C will be omitted.

The ejection head section 103 holds a head 114 (FIG. 4). The head 114 ejects droplets of the liquid material 111 in response to a signal coming from the control section 112. Since the head 114 of the ejection head section 103 is linked with the tank 101 by the tube 110, the liquid material 111 is supplied from the tank 101 to the head 114.

The stage 106 has a flat surface to stabilize the substrate 11 (FIG. 6). The stage 106 also has a function of fixing positions of the substrate 11 by use of suction.

The first position control unit 104 is fixed at a position at a predetermined height from the grand stage GS by the support section 104a. The first position control unit 104 has a function of moving the ejection head section 103 in an X-axis direction and a Z-axis direction perpendicular to the X-axis direction in response to the signal from the control section 112. Further, the first position control unit 104 also has a function of rotating the ejection head section 103 around an axis in parallel with the Z axis. In the embodiment, the Z-axis direction is a direction in parallel with a vertical direction (that is, a direction of gravitational acceleration).

The second position control unit 108 moves the stage 106 in a Y-axis direction on the grand stage GS. Here, the Y-axis direction is a direction perpendicular to both the X-axis and Z-axis directions.

The structure of the first position control unit 104 and the structure of the second position control unit 108 having the above-described functions can be realized by using a well-known XY robot utilizing a servomotor or a linear motor. Therefore, detailed descriptions of these structures are omitted.

Now, as thus described, the first position control unit 104 moves the ejection head section 103 in the X-axis direction. Then, the second position control unit 108 moves the substrate 11 together with the stage 106 in the Y-axis direction. As a result, a relative position of the head 114 to the substrate 11 changes. More specifically, by these operations, the ejection head section 103, the head 114, or a nozzle 118 (FIG. 4) moves, that is, scans, relative to the substrate 11 in the X-axis and Y-axis directions while keeping a predetermined distance from the substrate 11 in the Z-axis direction. “Moves relative to” or “scans relative to” means that at least one side, out of the sides that ejects the liquid material 111 and that the ejected material lands in (the landing portion 50), moves relative to the other side.

The control section 112 is structured so as to receive, from an external data processing unit, ejection data indicating relative positions at which the liquid material 111 is to be ejected. The control section 112 stores the received ejection data in an internal storage device and, at the same time, controls the first and second position control units 104 and 108 and the head 114 in response to the stored ejection data. In addition, the ejection data is data used for the application of the liquid material 111 onto the substrate 11 in a predetermined pattern. In the embodiment, the ejection data has a configuration of bit-map data.

The droplet ejection apparatus 300L having the above-described structure moves the nozzle 118 (FIG. 4) of the head 114 relative to the substrate 11 in response to the ejection data and, further, ejects the liquid material 111 from the nozzle 118 towards the landing portion 50.

To form a layer, a film, or a pattern by the inkjet method here means to form a layer, a film, or a pattern on a given matter using an apparatus such as the droplet ejection apparatus 300L.

Head

As shown in FIGS. 4A and 4B, the head 114 of the droplet ejection apparatus 300L is an inkjet head having a plurality of nozzles 118. More specifically, the head 114 is equipped with a diaphragm 126, a liquid reservoir 129, a plurality of partition walls 122, a plurality of oscillators 124, a nozzle plate 128 that sets the mouths of the plurality of nozzles 118, a supply port 130, and a hole 131. The liquid reservoir 129 is positioned between the diaphragm 126 and the nozzle plate 128, and a liquid alignment material 111 supplied from the tank outside (not shown) is constantly being filled in this liquid reservoir 129 via the hole 131.

The plurality of partition walls 122 are positioned between the diaphragm 126 and the nozzle plate 128. Further, a portion surrounded by the oscillator 126, the nozzle plate 128, and a pair of partition walls 122 is a cavity 120. Since the cavity 120 is disposed corresponding to the nozzle 118, the number of the cavities 120 is equal to the number of the nozzles 118. Into the cavity 120, the alignment material 111 in liquid form is supplied from the liquid reservoir 129 via the supply port 130, which is positioned between the pair of partition walls 122. In addition, in the embodiment, the diameter of the nozzle 118 is about 27 μm.

Now, each of the oscillators 124 is positioned corresponding to each of the cavities 120 on the diaphragm 126. Each of the oscillators 124 includes a piezoelectric element 124C and a pair of electrodes 124A and 124B that interpose this piezoelectric element 124C. When the control section 112 supplies a driving waveform between this pair of electrodes 124A and 124B, the corresponding nozzle 118 ejects droplets D of the liquid alignment material 111. In this case, the volume of the material ejected from the nozzle 118 is variable between 0 pl (pico liter) or more to 42 pl or less. Additionally, the shape of the nozzle 118 is adjusted so as to be able to eject the droplets D of the liquid alignment material 111 in the Z-axis direction.

In the present specification, a portion which includes one nozzle 118, the cavity 120 corresponding to the nozzle 118, and the oscillator 124 corresponding to the cavity 120 is also expressed as an “ejection part 127.” By this expression, one head 114 contains the same number of ejection parts 127 as that of the nozzles 118. Further, the ejection part 127 may include an electrothermal conversion element instead of the piezoelectric element. That is, the ejection part 127 may have a structure in which the material is ejected using thermal expansion of the material by use of the electrothermal conversion element.

Control Section

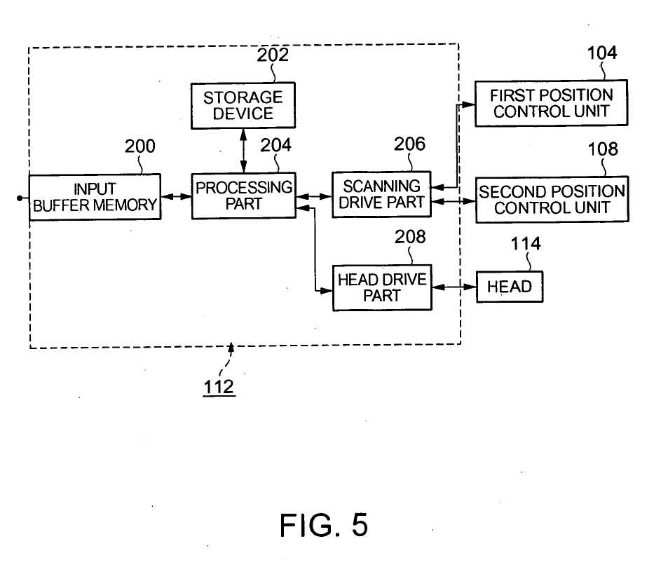

The structure of the control section 112 will now be described. As shown in FIG. 5, the control section 112 is equipped with an input buffer memory 200, a storage device 202, a processing part 204, a scanning drive part 206, and a head drive part 208. The input buffer memory 200 and the processing part 204 are connected so that they can communicate with each other. The processing part 204, the storage device 202, the scanning drive part 206, and the head drive part 208 are connected by a bus, which is not shown, so that they can communicate with each other.

The scanning drive part 206 is connected to the first and second position control units 104 and 108 so that they can communicate with each other. Similarly, the head drive part 208 is connected to the head 114 so that they can communicate with each other.

The input buffer memory 200 receives the ejection data for the ejection of the droplets of the liquid material 111 from the external data processing unit (not shown) placed outside the droplet ejection apparatus 300L. The input buffer memory 200 supplies the ejection data to the processing part 204, and the processing part 204 stores the ejection data in the storage device 202. In FIG. 5, the storage device 202 is RAM.

Based on the ejection data inside the storage device 202, the processing part 204 supplies data indicating the relative position of the nozzle 118 to the landing portion 50 to the scanning drive part 206. The scanning drive part 206 supplies a scanning drive signal in response to this data and cycles of ejection to the first and the second position control units 104 and 108. As a result, the relative position of the ejection head part 103 to the landing portion 50 changes. Meanwhile, the processing part 204 supplies the ejection signal necessary for the ejection of the liquid material 111 to the head 114 based on the ejection data stored in the storage device 202. As a result, the droplets D of the liquid material 111 are ejected from the corresponding nozzle 118 of the head 114.

The control section 112 is a computer containing a CPU, ROM, RAM, and a bus. Accordingly, the functions of the control section 112 as described above are performed by software programs executed by a computer. Of course, the control section 112 can be conducted by specialized circuits (hardware).

Liquid Material

The above-referenced “liquid material 111” is a material having such a viscosity that the droplets D can be ejected from the nozzle 118 of the head 114. In this case, the liquid material 111 can be either water-based or oil-based. It serves the purpose if the material has flowability (viscosity) that enables the ejection from the nozzle 118 and if the material is in fluid form as a whole even if it is mixed with solid materials. In this case, it is preferable that the viscosity of the liquid material 111 is between 1 mPa·s or more and 50 mPa·s or less. If the viscosity is 1 mPa·s or more, the periphery of the nozzle 118 does not easily get contaminated by the liquid material 111 when the droplets of the liquid material 111 are ejected. In contrast, if the viscosity is 50 mP·s or less, the clogging at the nozzle 118 does not occur as frequently, and, thereby, smooth ejection of the droplets D is possible. Both the lyophilic material 30A and conductive material 40A are liquid materials satisfying these conditions.

Further, if these liquid materials 111 contain microparticles, it is preferable that the average diameter of the microparticles is 1 μm or less. The liquid material 111 that satisfies this condition is ejected in a desired direction from the nozzle 118 of the head 114 without getting clogged. For example, the lyophilic material 30A contains the microparticles composed of silica (SiO₂) and titanium oxide (TiO₂), as mentioned earlier, whose average diameter is 1 μm or less. Also, the conductive material 40A, too, contains the silver particles, which have the average diameter of about 10 nm and thus satisfy this condition.

In addition, the “liquid material 111” is also called the “functional liquid,” since it performs specific functions after being applied to the landing portion 50.

Formation Method

Now, with reference to FIGS. 6 and 7, the electric wire formation method using the above-described droplet ejection apparatuses 300L and 300C will be described.

First, LW cleaning is conducted on the support substrate 10. Then, as shown in FIG. 6A, an organic resin material containing a silane coupling agent as fluorine-containing organic molecules is applied by a spin coating method so as to cover the support substrate 10. As a consequence, an organic resin thin film 20A is formed on the support substrate 10. Then, by further applying a negative type, chemically amplifying type acrylic photosensitive resist to cover the entire surface of the organic resin thin film 20A, a resist layer 20B is formed on the organic resin thin film 20A.

Then, the resist layer 20B and the organic resin thin film 20A are patterned using photolithography. More specifically, as shown in FIG. 6B, the resist layer 20B is irradiated with light hv via a photomask PM having a shield AB at a portion corresponding to a region where the conductive layer 40 is to be formed. Then, after developing the resist layer 20B, a part where the light hv is not irradiated, that is, a part of the resist layer 20B and the organic resin thin film 20A that corresponds to the conductive layer 40 is removed by etching using a specified etching liquid. As a consequence, as shown in FIG. 6C, the bank pattern 20 made from the organic resin material and the resist layer 20B, which are configured so as to surround the conductive layer 40 to be formed later on, remains on the support substrate 10. Thereafter, the resist layer 20B is peeled off using a specified chemical solution, and, as shown in FIG. 6D, the landing portion 50 defined by the band pattern 20 and the surface of the support substrate 10 is formed on the support substrate 10. Here, the surface of the support substrate 10 and the bank pattern 20 is taking the shape of a groove. The surface of the support substrate 10 constitutes the bottom part of the groove.

As described, the bank pattern 20 is formed in a manner that the surface of the support substrate 10 becomes the bottom part of the groove.

Then, plasma processing is conducted at the surface of the bank pattern 20. The plasma processing is conducted by subjecting the substrate 11 having the bank pattern 20 formed thereon to a gas containing a fluorocarbon compound, and by feeding energy to the gas to turn it into plasma that reacts at the surface of the bank pattern 20. By this plasma processing, it is possible to improve the liquid repellency of the bank pattern 20 against the conductive material 40A.

Thereafter, the lyophilic material 30A and the conductive material 40A, in this order, are disposed on the landing portion 50 formed on the support substrate 10. These steps are carried out using the manufacturing equipment 2 shown in FIG. 2.

The substrate 11 having the landing portion 50 is moved to the stage 106 of the droplet ejection apparatus 300L by the transfer apparatus 270. Then, as shown in FIG. 7A, the droplet ejection apparatus 300L ejects the lyophilic material 30A from the ejection part 127 of the head 114 so that the layer of the lyophilic material 30A is formed on all of the landing portions 50. More specifically, the droplet ejection apparatus 300L ejects the lyophilic material 30A onto the surface of the support substrate 10 that constitutes the bottom part of the landing portion 50. When the layer of the lyophilic material 30A is formed at all of the landing portions 50 on the substrate 11, the transfer apparatus 270 positions the substrate 11 inside the dryer 350L. Thereafter, by completely drying the lyophilic material 30A on the landing portion 50, the lyophilic layer 30 is formed on the landing portion 50, and, as shown in FIG. 7A, the landing portion 50 having the lyophilic layer 30 as its bottom part is formed.

The substrate 11 having thus formed lyophilic layer 30 is moved to the light irradiation apparatus 400L by the transfer apparatus 270. Then, the light irradiation apparatus 400L irradiates the substrate 11 with the light having the wavelength of 400 nm or less. The lyophilic layer 30 has a characteristic of reacting with the light having such a wavelength and thereby enhancing its own lyophilic property. Thus, the lyophilic layer 30 that underwent this light-irradiating step becomes more highly lyophilic to the conductive material 40A.

Additionally, although the light irradiation apparatus 400L irradiates the light having the wavelength of 400 nm or less as described, the light wavelength contributing to an actual reaction differs depending on the kind of the microparticles contained in the lyophilic layer 30. More specifically, the lyophilic layer 30 including the microparticles of silica (SiO₂) and the metal-containing microparticles reacts with light having a wavelength of 400 nm or less, at which the metal-containing microparticles act as the light catalyst. For example, the lyophilic layer 30 including the microparticles composed of silica (SiO₂) and titanium oxide (TiO₂), as used in the embodiment, reacts with the light whose wavelength is 380 nm or less, at which the microparticles of titanium oxide (TiO₂) act as the light catalyst. In addition, the lyophilic layer 30 including only the microparticles of silica (SiO₂) reacts with the light whose wavelength is 250 nm or less.

Thereafter, the substrate 11 having the lyophilic layer 30 is moved to the stage 106 of the droplet ejection apparatus 300C by the transfer apparatus 270. Then, as shown in FIG. 7B, the droplet ejection apparatus 300C ejects the conductive material 40A from the ejection part 127 of the head 114 so that the layer of the conductive material 40A is formed on all of the landing portions 50. More specifically, the droplet ejection apparatus 300C ejects the conductive material 40A onto the surface of the lyophilic layer 30 that constitutes the bottom parts of the landing portions 50. When the layer of the conductive material 40A is formed at all of the landing portions 50 on the substrate 11, the transfer apparatus 270 positions the substrate 11 inside the dryer 350C. Then, when the conductive material 40A on the landing portion 50 is dried in high temperature atmosphere, the fusion or welding takes place among the silver particles contained in the conductive material 40A, thereby forming the conductive layer 40 of a low resistance conductive matter. Hence, the wiring substrate 1 having the conductive layer 40 as the electric wires is obtained.

The lyophilic property of the lyophilic layer 30 against the conductive material 40A is higher than that of the bank pattern 20 against the conductive material 40A. This is because the bank pattern 20 contains the silane coupling agent or the like as the fluorine-containing organic molecules and, at the same time, the liquid repellency of the bank pattern 20 is enhanced by the plasma processing, and because the lyophilic property of the lyophilic layer 30 is further enhanced by the light irradiation to the already highly lyophilic layer 30 containing the microparticles composed of silica (SiO₂) and titanium oxide (TiO₂). For these reasons, the droplets of the conductive material 40A landed at the surface of the lyophilic layer 30 that constitutes the bottom part of the landing portion 50 repel the bank pattern 20 and, at the same time, try to spread on the lyophilic layer 30. Because of such a mechanism, the conductive material 40A spreads on the lyophilic layer 30 uniformly and evenly, and the conductive layer 40 obtained by drying thus spread conductive material 40A is formed as the layer having an even thickness.

In addition, even when residues of the bank pattern 20 remain at the bottom part of the landing portion 50, the lyophilic layer 30 is formed while covering the residues, and, thus, by the same reasons as described above, the conductive layer 40 having the even thickness can be formed.

Thus obtained electric wires have the uniformly and evenly thick conductive layer 40 and, accordingly, have good conductivity. Further, even if the electric wires have an extremely minute pattern, the conductive material 40A spreads uniformly and evenly at the bottom part of the landing portion 50, since the lyophilic property of the lyophilic layer 30 against the conductive material 40A is higher than that of the bank pattern 20 against the conductive material 40A. As a consequence, the electric wires having the uniformly and evenly thick conductive layer 40 can also be formed having even if they have an extremely minute pattern.

Mounting Process

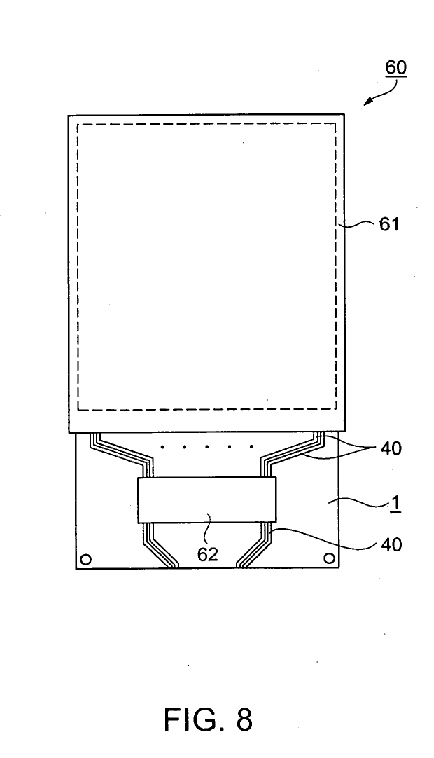

Next, as shown in FIG. 8, a liquid crystal panel 61 and a semiconductor element 62 will be mounted on the wiring substrate 1 manufactured in the described steps. More specifically, a pad corresponding to the liquid crystal panel 61 or a pad corresponding to the semiconductor element 62 is suitably adhered to the pattern of the conductive layer 40 on the wiring substrate 1. Accordingly, a liquid crystal display device 60 is obtained. Thus, the electric wire formation method of the embodiment can be applied to the manufacture of the liquid crystal display device 60. In the embodiment, the semiconductor element 62 is a liquid crystal driver circuit.

Moreover, the electric wire formation method of the embodiment can be applied, not only to the manufacture of the liquid crystal display device, but also to the manufacture of various types of electrooptical devices. The “electrooptical device” indicated here is not limited to a device utilizing changes in optical characteristics (that is, electrooptical effects), such as changes in birefringence, optical rotatory power, or light scattering, but is a device in general that projects, transmits, or reflects light in response to supply of signal voltage.

More specifically, the electrooptical device is a term that includes: a liquid crystal display device, an electroluminescence display device, a plasma display device, a surface-conduction electron-emitter display (SED), a field emission display (FED), and the like.

Further, the electric wire formation method of the embodiment can also be applied to the manufacture of the electrooptical element contained in the above-referenced electrooptical devices. More specifically, the electric wire formation method can be applied to the formation of, for example, a thin film transistor (TFT) element formed at a pixel part of the electrooptical device, to electric wires such as scanning lines, signal lines, and the like, and pixel electrodes.

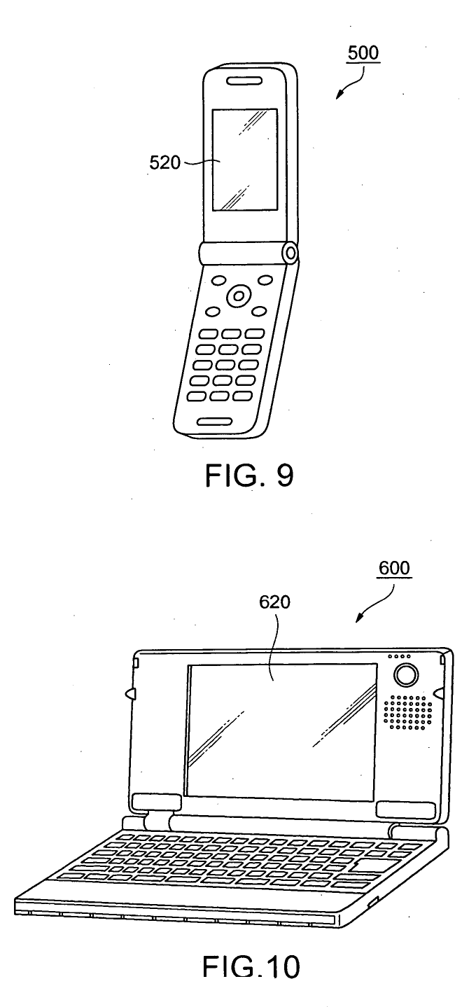

Furthermore, the electric wire formation method of the embodiment can also be applied to methods for manufacturing various electronic apparatuses. For example, the electric wire formation method of the embodiment can be applied to a method for manufacturing a cellular phone 500 equipped with an electrooptical device 520 as shown in FIG. 9 and to a method for manufacturing a personal computer 600 equipped with an electrooptical device 620 as shown in FIG. 10.

### Second Embodiment

In the first embodiment, the lyophilic layer 30 is formed at the landing portion 50 after the bank pattern 20 is formed. In contrast, in the second embodiment, the bank pattern 20 is formed on the surface of the lyophilic layer 30 after the lyophilic layer 30 is applied to the entire surface of the support substrate 10. Except for this point, the second embodiment is basically the same as the first embodiment. Further, similarly to the foregoing descriptions, the wiring substrate 1, before being provided with the conductive layer 40, is expressed as the substrate 11.

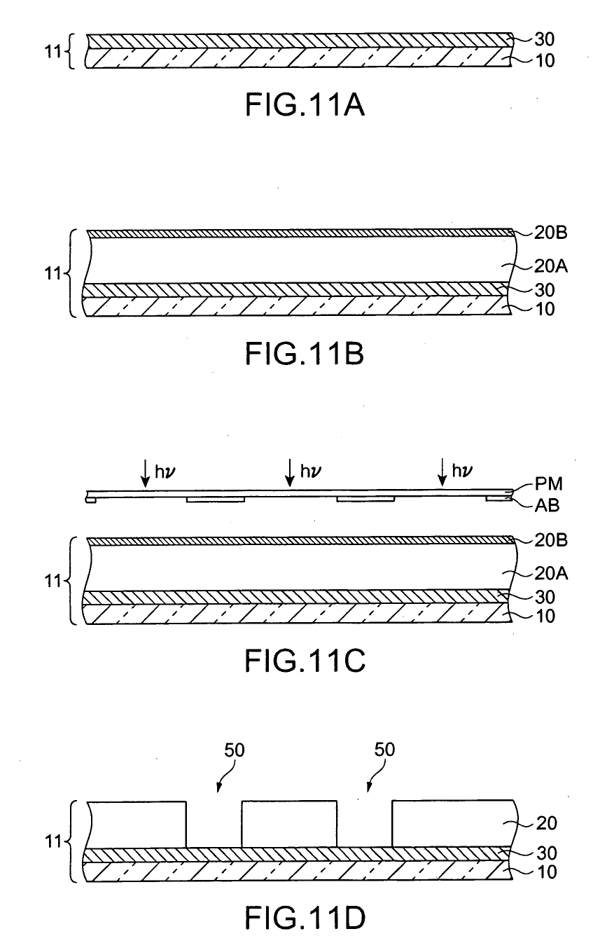

First, the UV cleaning is conducted on the support substrate 10. Then, the support substrate 10 is moved to the stage 106 of the droplet ejection apparatus 300L by the transfer apparatus 270 inside the manufacturing equipment 2. Then, the droplet ejection apparatus 300L ejects the lyophilic material 30A from the ejection part 127 of the head 114 so as to form the layer of the lyophilic material 30A on the support substrate 10. Upon forming the layer of the lyophilic material 30A on the support substrate 10, the transfer apparatus 270 positions the substrate 11 inside the dryer 350L. Then, as shown in FIG. 11A, the lyophilic layer 30 is formed on the support substrate 10 by completely drying the lyophilic material 30A.

The substrate 11 having the lyophilic layer 30 formed thereon is moved to the light irradiation apparatus 400L by the transfer apparatus 270. Then, the light irradiation apparatus 400L irradiates the substrate 11 with the light having the wavelength of 400 nm or less. The lyophilic layer 30 has a characteristic of reacting with the light having such a wavelength and thereby enhancing its lyophilic property. Thus, the lyophilic property of the lyophilic layer 30 that underwent this light-irradiating step is enhanced against the conductive material 40A.

Additionally, although the light irradiation apparatus 400L irradiates the light having the wavelength of 400 nm or less as described, the light wavelength contributing to an actual reaction differs depending on the kind of microparticles contained in the lyophilic layer 30. More specifically, the lyophilic layer 30 including the microparticles of silica (SiO₂) and the metal-containing microparticles reacts with light having a wavelength of 400 nm or less, at which these metal-containing microparticles act as the light catalyst. For example, the lyophilic layer 30 including the microparticles composed of silica (SiO₂) and titanium oxide (TiO₂), as used in the embodiment, reacts with the light whose wavelength is 380 nm or less, at which the microparticles of titanium oxide (TiO₂) act as the light catalyst. Further, the lyophilic layer 30 including only the microparticles of silica (SiO₂) reacts with the light whose wavelength is 250 nm or less.

Now, the substrate 11 is taken out of the manufacturing equipment 2 and undergoes the step of forming the bank pattern 20. That is, as shown in FIG. 11B, the organic resin thin film 20A is first formed on the surface of the lyophilic layer 30 using the spin coating method. Then, by applying a negative type, chemically amplifying type acrylic photosensitive resist so as to cover the entire surface of the organic resin thin film 20A, the resist layer 20B is formed on the organic resin thin film 20A.

Then, as shown in FIGS. 11C and 11D, the resist layer 20B and the organic resin thin film 20A are patterned using photolithography, and, thereafter, the resist layer 20B is peeled off to produce the bank pattern 20.

Thereafter, the surface of the bank pattern 20 is subject to the plasma processing in order to enhance its liquid repellency. As for the method of patterning the resist layer 20B and the organic resin thin film 20A, the method of peeling off the resist layer 20B, and the plasma processing method, detailed descriptions thereof will be omitted since they are the same as those in the first embodiment.

Thus, as shown in FIG. 11D, the landing portion 50 whose bottom part is the lyophilic layer 30 is formed on the support substrate 10.

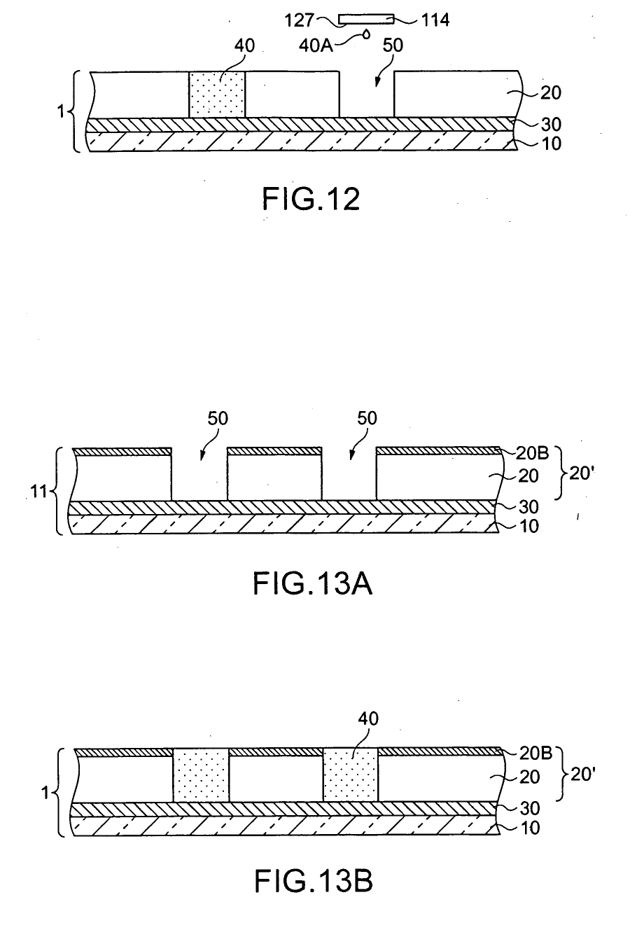

The substrate 11 having the landing portion 50 formed thereon is now brought back to the manufacturing equipment 2 and moved to the stage 106 of the droplet ejection apparatus 300C by the transfer apparatus 270. Then, as shown in FIG. 12, the droplet ejection apparatus 300C ejects the conductive material 40A from the ejection part 127 of the head 114 so that the layer of the conductive material 40A is formed at all of the landing portions 50. More specifically, the droplet ejection apparatus 300C ejects the conductive material 40A onto the surface of the lyophilic layer 30 that constitutes the bottom part of the landing portion 50. When the layer of the conductive material 40A is formed at all of the landing portions 50 on the substrate 11, the transfer apparatus 270 positions the substrate 11 inside the dryer 350C. Then, when the conductive material 40A on the landing portion 50 is dried in high temperature atmosphere, the fusion or welding takes place among the silver particles contained in the conductive material 40A, thereby generating the conductive layer 40 of a low resistance conductive matter. As a consequence, the wiring substrate 1 having the conductive layer 40 as the electric wires is obtained.

The lyophilic property of the lyophilic layer 30 against the conductive material 40A is higher that that of the bank pattern 20 against the conductive material 40A. This is because the bank pattern 20 contains the silane coupling agent or the like as the fluorine-containing organic molecules and, at the same time, the liquid repellency of the bank pattern 20 is enhanced by the plasma processing, and because the lyophilic property of the lyophilic layer 30 is further enhanced by the light irradiation to the already highly lyophilic layer 30 containing the microparticles composed of silica (SiO₂) and titanium oxide (TiO₂). For these reasons, the droplets of the conductive material 40A landed on the surface of the lyophilic layer 30 that constitutes the bottom part of the landing portion 50 repel against the bank pattern 20 and, at the same time, try to spread on the lyophilic layer 30. Because of such a mechanism, the conductive material 40A spreads on the lyophilic layer 30 uniformly and evenly, and the conductive layer 40 obtained by drying thus spread conductive material 40A is formed as the layer having an even thickness.

In addition, even when residues of the bank pattern 20 remain at the bottom part of the landing portion 50, the lyophilic layer 30 is formed while covering these residues, and, thus, by the same reasons as described above, the conductive layer 40 having the even thickness can be formed.

Thus obtained electric wires have the uniformly and evenly thick conductive layer 40 and, accordingly, have good conductivity. Further, even if the electric wires have an extremely minute pattern, the conductive material 40A spreads uniformly and evenly at the bottom part of the landing portion 50, since the lyophilic property of the lyophilic layer 30 against the conductive material 40A is higher than that of the bank pattern 20 against the conductive material 40A. As a consequence, the electric wires having the uniformly and evenly thick conductive layer 40 can also be formed even if they have an extremely minute pattern.

### Third Embodiment

In the first and second embodiments, the resist layer 20B applied for the formation of the bank pattern 20 is peeled off after the patterning of the organic resin thin film 20A and the resist layer 20B. However, it is possible to manufacture the electric wires without peeling off the resist layer 20B, if the resist layer 20B itself acquires the liquid repellency against the conductive material 40A. In the following, the third embodiment using such a method will be described.

The electric wire formation method of the third embodiment is identical to the electric wire formation method of the second embodiment, except for the elements as will be described below. Therefore, descriptions of the elements similar to those in the second embodiment will be omitted.

FIGS. 13A and 13B are diagrams illustrating the electric wire formation method of the embodiment. FIG. 13A shows the substrate 11 in a state in which, after providing the substrate 11 with lyophilic layer 30, the organic resin thin film 20A, and the resist layer 20B, the resist layer 20B is irradiated with light and patterned using photolithography.

Here, a photoresist composed of a fluorine-containing polymer compound is used for the resist layer 20B. The resist layer 20B made from such a material has the liquid repellency against the conductive material 40A.

In the embodiment, the resist layer 20B is not peeled off hereafter. Accordingly, a constituent element of the bank pattern 20 in the second embodiment is a lamination of the bank pattern 20 composed of the organic resin thin film and the resist layer 20B. Hereafter, the lamination of the bank pattern 20 and the resist layer 20B is called a bank pattern 20′. The side surface of the landing portion 50 in the embodiment is defined by the bank pattern 20′. Further, since the bank pattern 20′ includes the resist layer 20B having the liquid repellency on the surface, it is not necessary to carry out the plasma processing in order to improve the liquid repellency of the bank pattern 20′.

Then, as shown in FIG. 13B, the conductive layer 40 is formed at the landing portion 50 by the steps as described in the second embodiment.

The conductive layer 40 of thus obtained electric wire has the uniform and even thickness. This is because the lyophilic layer 30 is more lyophilic to the conductive material 40A than the bank pattern 20′ is to the conductive material 40A, and, as a result, the conductive material 40A repels against the bank pattern 20′ and, at the same time, tries to spread on the lyophilic layer 30.

The electric wires formed by the formation method of the embodiment have the same effects as those of the electric wires formed by the formation method of the second embodiment. In addition, with the manufacturing method of the embodiment, the electric wire formation steps can be simplified, since it is not required to undergo the steps of peeling off the resist layer 20B and of subjecting the bank pattern 20′ to the plasma processing.

The embodiments of the invention have now been described. However, various modifications to these embodiments are possible within the scope of the invention. Possible modified examples are as follows.

### MODIFIED EXAMPLE 1

In the previous embodiments, the two separate droplet ejection apparatuses 300L and 300C eject the lyophilic material 30A and the conductive material 40A, respectively. In substitution for such a structure, one droplet ejection apparatus (such as the droplet ejection apparatus 300L) may eject both of these liquid materials. In this case, the liquid materials may be ejected from different nozzles 118 of the droplet ejection apparatus 300L or from one nozzle 118 of the droplet ejection apparatus 300L. If one nozzle 118 ejects these two liquid materials, a process of cleaning the path from the tank 101 to the nozzle 118 may only be added at the time of switching the two liquid materials.

### MODIFIED EXAMPLE 2

In the second and the third embodiments, the lyophilic layer 30 is formed by the inkjet method using the droplet ejection apparatus 300L. However, the lyophilic layer 30 may be formed by any method by which the liquid materials are applied. Examples of such a method that can be applied for the formation of the lyophilic layer 30 are: extrusion coating method, spin coating method, gravure coating method, reverse roll coating method, rod coating method, slit coating method, micro-gravure coating method, dip coating method, flexographic printing method, and screen printing method.

### MODIFIED EXAMPLE 3

In the embodiments, the lyophilic material 30A includes the microparticles composed of silica (SiO₂) and titanium oxide (TiO₂). However, the lyophilic material 30A may include, independently, particles of silica (SiO₂) and particles of titanium oxide (TiO₂). Alternatively, the material 30A may include only the microparticles of silica (SiO₂). Alternatively, in substitution for titanium oxide (TiO₂), microparticles composed of at least one selected from zinc oxide (ZnO), tin oxide (SnO₂), strontium titanate (SrTi₃), tungsten oxide (WO₃), bismuth oxide (Bi₂O₃), and iron oxide (Fe₂O₃) may be included. Such a lyophilic material 30A has the lyophilic property against the conductive material 40A.

Further, the lyophilic material 30A may be a material including microparticles composed of a combination of at least two selected from silica, titanium oxide, zinc oxide, tin oxide, strontium titanate, tungsten oxide, bismuth oxide, and iron oxide. Furthermore, a material including microparticles containing the above-referenced metals such as titanium oxide and zinc oxide that are coated with silica can be used. These lyophilic materials 30A also have the lyophilic property against the conductive material 40A.

### MODIFIED EXAMPLE 4

In the embodiments, the lyophilic layer 30 is irradiated with light having the wavelength of 400 nm or less in order to improve the lyophilic property of the lyophilic layer 30. However, this step may be omitted. In this case, although the lyophilic layer 30 becomes less lyophilic to the conductive material 40A, it is still more lyophilic than the bank pattern 20 is to the conductive material 40A. Therefore, in this modified example, the electric wire formation process can be simplified by omitting the light irradiation step.

### MODIFIED EXAMPLE 5

In the embodiments, the bank pattern 20 includes fluorine-containing organic molecules, more specifically, CF₃CF₂CF₂CF₂CF₂CF₂CF₂CF₂CH₂CH₂—Si(OCH₃)₃, which is a kind of a silane coupling agent. However, other silane coupling agents may be used. A silane coupling agent is a compound expressed by R¹SiX¹mX²(3-m), where R¹ represents an organic group; X¹ and X² represent —OR², —R², and —Cl where R² represents an alkyl group whose carbon number is from 1 to 4; and m is an integer of from 1 to 3. Examples of the suitable silane coupling agent to be contained in the bank pattern 20 that can impart the liquid repellency to the bank pattern 20 are: CF₃(CF₂)₃—CH₂CH₂—Si(OCH₃)₃, CF₃(CF₂)₆—CH₂CH₂—Si(OCH₃)₃, CF₃(CF₂)₆—CH₂CH₂—Si(OC₂H₆)₃, CF₃(CF₂)₇—CH₂CH₂—Si(OCH₃)₃, CF₃(CF₂)₁₁—CH₂CH₂—Si(OC₂H₆)₃, CF₃(CF₂)₃—CH₂CH₂—Si(CH₃)(OCH₃)₂, CF₃(CF₂)₇—CH₂CH₂—Si(CH₃) (OCH₃)₂, CF₃(CF₂)₅—CH₂CH₂—Si(CH₃) (OC₂H₆)₂, CF₃(CF₂)₈—CH₂CH₂—Si(C₂H₆) (OC₂H₆)₂, CF₃O(CF₂O)₆—CH₂CH₂—Si(OC₂H₅)₃, CF₃O(C₃F₆O)₄—CH₂CH₂—Si(OCH₃)₃, CF₃O(C₃F₆O)₂(CF₂O)₃—CH₂CH₂—Si(OCH₃)₃ CFO₃, (C₃F₆O)₈—CH₂CH₂—Si(OCH₃)₃, CF₃O(C₄F₈O)₆—CH₂CH₂—Si(OCH₃)₃, CF₃O(C₄F₈O)₈—CH₂CH₂—Si(CH₃)(0C₂H₅)₂, and CF₃O(C₃F₆O)₄—CH₂CH₂—Si(C₂H₆)(OCH₃)₂.

Further, in substitution for the silane coupling agent, a fluorine-containing surfactant can be used. A surfactant is a compound expressed by R¹Y¹, where Y¹ is a lyophilic polar group, namely, —OH, —(CH₂CH₂O)ₙH, —COOH, —COOK, —COONa, —PO₃H₂, —PO₂Na₂, —PO₃K₂, —NO₂, —NH₂, —NH₃Cl (ammonium salt), —NH₃Br (ammonium salt), ≡NHCl (pyridinium salt), ≡NHBr (pyridinium salt), or the like. Example surfactants suitable to be contained in the bank pattern 20 that can impart liquid repellency to the bank pattern 20 are: CF₃—CH₂CH₂—COONa, CF₃(CF₂)₃—CH₂CH₂—COONa, CF₃(CF₂)₆—CH₂CH₂—NH₃Br, CF₃(CF₂)₆—CH₂CH₂—NH₃Br, CF₃(CF₂)₇—CH₂CH₂—NH₃Br, CF₃(CF₂)₁₁—CH₂CH₂—NH₃Br, CF₃(CF₂)₃—CH₂CH₂—NH₃Br, CF₃(CF₂)₇—CH₂CH₂—OSO₃Na, CF₃(CF₂)₅—CH₂CH₂—OSO₃Na, CF₃(CF₂)₈—CH₂CH₂—OSO₃Na, CF₃O(CF₂O)₆—CH₂CH₂—OSO₃Na, CF₃O(C₃F₆O)₄—CH₂CH₂—OSO₃Na, CF₃O(C₃F₆O)₂(CF₂O)₃—CH₂CH₂—OSO₃Na, CF₃O(C₃F₆O)₅—CH₂CH₂—OSO₃Na, CF₃O(C₄F₈O)₅—CH₂CH₂—OSO₃Na, and CF₃O(C₃F₆O)₄—CH₂CH₂—OSO₃Na.

Because terminal functional groups of the molecules of the silane coupling agent and surfactant are chemically absorbed in atoms constituting the substrate surface, the silane coupling agent and the surfactant are reactive at the oxide surface of wide-ranged materials such as metal and insulators. In particular, if R₁ contained in the silane coupling agent and the surfactant includes the fluorine atoms such as a perfluoroalkyl structure, CₙF₂ₙ₊₁, or a perfluoroalkyl ether structure, CₚF₂ₚ₊₁O(CₚF₂ₚO)ᵣ (where n, p, and r are integers), the silane coupling agent and the surfactant can be suitably used as the liquid repellent substance. This is because the surface-free energy of the solid surface modified by these silane coupling agent and surfactant becomes lower than 25 mJ/m2 and, therefore, the silane coupling agent and the surfactant have sufficient liquid repellency.

Further, a highly liquid repellent polymer compound may be used for the bank pattern 20. As the highly liquid repellent polymer compound, oligomer and polymer containing fluorine atoms in their molecules can be used. More specifically, poly-4-ethylene fluoride (PTFE), ethylene/4-fluoroethylene copolymer, 6-fluoropropylene 4-fluoroethylene copolymer, polyvinylidene fluoride (PVdF), poly(pentadecafluoroheptylethyl methacrylate) (PPFMA), or a polyethylene-, polyester-, polyacrylate-, polymethacrylate-, polyvinyl-, polyurethane-, polysiloxane-, polyimide-, or polycarbonate-based polymer compound having a long-chane perfluoroalkyl structure such as poly(perfluorooctylethyl acrylate) may be used.

### MODIFIED EXAMPLE 6

In the third embodiment, the photoresist composed of the fluorine-containing polymer compound is used for the resist layer 20B. However, a photoresist mixed with fluorine-containing organic molecules may be used. The resist layer 20B formed using such a photoresist has the liquid repellency against the conductive material 40A. Thus, similarly to the third embodiment, the conductive layer 40 having a uniform and even thickness can be applied. As the fluorine-containing organic molecules, the above-referenced surfactant is preferable. More specifically, a fluorine-based nonionic surfactant or an amphoteric (cationic and anionic) surfactant, such as hydrocarbons of NIKKOL BL, BC, BO, and BB series manufactured by Nihon Surfactant Kogyo K.K., ZONYL FSN and FSO manufactured by Du Pont, Surflon S-141 and S-145 manufactured by Asahi Glass Co., Ltd., Megafac F-141 and F-144 manufactured by Dainippon Ink & Chemicals, Inc., Ftergent F-200 and F-251 manufactured by NEOS, UNIDYNE DS-401 and DS-402 manufactured by Daikin Industries, Ltd., Fluorad FC-170 and FC-176 manufactured by 3M, EFTOP EF series manufactured by JEMCO, or the like can be used. By adjusting the kind and amount of these surfactants to be added to the photoresist, the liquid repellency of the photoresist can be adjusted as desired.

### MODIFIED EXAMPLE 7

In the embodiments, the bank pattern 20 is formed by patterning the organic resin thin film 20A and the resist layer 20B. However, the bank pattern 20 may be formed only using the resist layer 20B if the liquid-repellent material is used for the resist layer 20B. More specifically, the bank pattern 20 may be formed by applying the resist layer 20B without applying the organic resin thin film 20A and, then, by patterning the resist layer 20B. Even if the bank pattern 20 is formed by such a method, the lyophilic layer 30 is still more lyophilic to the conductive material 40A than the bank pattern 20 is to the conductive material 40A, and, thus, the evenly thick conductive layer 40 can be formed.

### MODIFIED EXAMPLE 8

In the first and second embodiments, the surface of the bank pattern 20 was subjected to the plasma processing. However, this step may be omitted. In this case, although the bank pattern 20 becomes less liquid-repellent to the conductive material 40A, the electric wire formation process can be simplified since the plasma processing step can be omitted.

### MODIFIED EXAMPLE 9

In the embodiments, the conductive material 40A is the metal microparticle dispersion including silver particles and water as the dispersion medium. However, particles composed of various kinds of materials other than the silver particles may be used. More specifically, particles composed of metal, alloy, or metal oxide containing more than two elements selected from gold, platinum, silver, copper, nickel, chromium, rhodium, palladium, zinc, cobalt, molybdenum, rhuthenium, tungsten, osmium, iridium, iron, manganese, germanium, tin, antimony, gallium, and indium may be used. In particular, particles composed of gold, silver, copper, nickel, manganese, indium tin oxide (ITO), or antimony tin oxide (ATO) are preferable. Further, it is preferable that these particles are covered by a polymer or a surfactant so that they are stably dispersed in the dispersion medium.

The conductive material 40A may be a metallic complex compound solution whose medium is water. The metallic complex compound is also called a coordinate compound and is a compound having, in its center, a conductive particle composed of metal ion, metal, platinum, or metal oxide, which is surrounded by ions or molecules. More specifically, a metallic complex compound having, in its center, conductive particles composed of metal ion, metal, alloy, or metal oxide containing more than two elements of gold, platinum, silver, copper, nickel, chromium, rhodium, palladium, zinc, cobalt, molybdenum, rhuthenium, tangsten, osmium, iridium, iron, manganese, germanium, tin, antimony, gallium, and indium can be used. The ligand can be chosen as desired. With the conductive material 40A composed of such a metallic complex compound solution, also, the fusion or welding takes place among the central conductive particles when applied and baked at high temperature or irradiated with light, and, thus, the conductive layer 40 of the low resistance conductive matter is generated.

Additionally, although water was the dispersion medium of the metal microparticle dispersion composing the conductive material 40A and the medium of the metallic complex compound solution, the medium is not limited to water so long as it can disperse the conductive particles such as silver particles and can prevent aggregation. Other than water, an example medium is: alcohol such as methanol, ethanol, propanol, butanol, hexanol, octanol, or cyclohexanol; a hydrocarbon compound such as n-heptane, n-octane, decane, dodecane, tetradecane, hexadecane, toluene, xylene, cymene, durene, indene, dipentene, tetrahydronaphthalene, decahydronaphthalene, cyclohexane, or cyclohexylbenzene; an ether compound such as ethyleneglycol dimethyl ether, ethyleneglycol diethyl ether, ethyleneglycol methyl ethyl ether, diethyleneglycol dimethyl ether, diethyleneglycol diethyl ether, diethyleneglycol methyl ethyl ether 1,2-dimethoxyethane, bis(2-methoxylethyl) ether, or p-dioxane; or a polar compound such as proplylene carbonate, γ-butyrolactone, n-methyl-2-pyrrolidone, dimethyl formamide, dimethyl sulfoxide, α-terpineol, or cyclohexanone. Among these, one having a high surface tension is desirable in view of its high liquid repellency to the bank pattern 20, and, further, in views of dispersibility of the conductive particles, stability of the dispersion, and applicability to the droplet ejection method (the inkjet method), water, alcohol, hydrocarbon compound, or ether compound is preferable. A more preferable medium may be water or hydrocarbon compound.

### MODIFIED EXAMPLE 10

In the embodiments, a multilayer structure is formed on the support substrate 10 composed of polyimide. However, the same effects as described in the embodiments can be produced by using a ceramic substrate, glass substrate, epoxy substrate, glass epoxy substrate, or a silicon substrate in substitution for the support substrate 10.

The entire disclosure of Japanese Patent Application No. 2004-357716, filed Dec. 10, 2004 is expressly incorporated by reference herein.

What is claimed is:

1. A method for forming electric wire by disposing a functional liquid by using a droplet ejection apparatus, comprising:
a) forming on a substrate a partition wall defining a groove in a manner that a surface of the substrate becomes a bottom part of the groove;
b) forming on the bottom part a lyophilic layer having a higher lyophilic property against a first functional liquid than a lyophilic property of the partition wall against the first functional liquid; and
c) disposing on the lyophilic layer the first functional liquid containing metal by using a droplet ejection apparatus.

2. The electric wire formation method according to claim 1, wherein the lyophilic layer formation process comprises forming the lyophilic layer by disposing a second functional liquid containing microparticles of silica on the bottom part.

3. The electric wire formation method according to claim 2, wherein the second functional liquid further contains microparticles of at least one selected from titanium oxide, zinc oxide, tin oxide, strontium titanate, tungsten oxide, bismuth oxide, and iron oxide.

4. The electric wire formation method according to claim 1, wherein the lyophilic layer formation process b) comprises forming the lyophilic layer on the bottom part by disposing the second functional liquid containing microparticles composed of a combination of at least two selected from silica, titanium oxide, zinc oxide, tin oxide, strontium titanate, tungsten oxide, bismuth oxide, and iron oxide.

5. The electric wire formation method according to claim 1, wherein the lyophilic layer formation process b) further comprises forming the lyophilic layer on the bottom part by disposing the second functional liquid containing microparticles composed of a combination of silica with at least two selected from titanium oxide, zinc oxide, tin oxide, strontium titanate, tungsten oxide, bismuth oxide, and iron oxide.

6. The electric wire formation method according to claim 2, wherein an average diameter of the microparticle is 1 μm or less.

7. The electric wire formation method according to claim 1, wherein the partition wall formation process a) comprises forming the partition wall using a photoresist mixed with a fluorine-containing polymer compound.

8. The electric wire formation method according to claim 1, wherein the partition wall formation process a) further comprises forming the partition wall using a photoresist mixed with a fluorine-containing organic molecule.

9. A method for forming electric wire by disposing a functional liquid by using a droplet ejection apparatus, comprising:
a) forming on a substrate a lyophilic layer having a higher lyophilic property against a first functional liquid than a lyophilic property of a partition wall against the first functional liquid;
b) forming on the lyophilic layer the partition wall defining a groove in a manner that the lyophilic layer becomes a bottom part of the groove; and
c) disposing on the bottom part the first functional liquid containing metal by using a droplet ejection apparatus.

10. The electric wire formation method according to claim 9, wherein the lyophilic layer formation process a) comprises forming the lyophilic layer by disposing a second functional liquid containing microparticles of silica on the bottom part.

11. The electric wire formation method according to claim 10, wherein the second functional liquid further contains microparticles of at least one selected from titanium oxide, zinc oxide, tin oxide, strontium titanate, tungsten oxide, bismuth oxide, and iron oxide.

12. The electric wire formation method according to claim 9, wherein the lyophilic layer formation process a) further comprises forming the lyophilic layer on the bottom part by disposing the second functional liquid containing microparticles composed of a combination of at least two selected from silica, titanium oxide, zinc oxide, tin oxide, strontium titanate, tungsten oxide, bismuth oxide, and iron oxide.

13. The electric wire formation method according to claim 9, wherein the lyophilic layer formation process a) further comprises forming the lyophilic layer on the bottom part by disposing a second functional liquid containing microparticles composed of a combination of silica with at least two selected from titanium oxide, zinc oxide, tin oxide, strontium titanate, tungsten oxide, bismuth oxide, and iron oxide.

14. The electric wire formation method according to claim 10, wherein an average diameter of the microparticle is 1 μm or less.

15. The electric wire formation method according to claim 9, wherein the partition wall formation process b) comprises forming the partition wall using a photoresist mixed with a fluorine-containing polymer compound.

16. The electric wire formation method according to claim 9, wherein the partition wall formation process b) further comprises forming a partition wall using a photoresist mixed with a fluorine-containing organic molecule.

17. The electric wire formation method according to claim 1, further comprising irradiating the lyophilic layer with light.

18. The electric wire formation method according to claim 17, wherein a wavelength of the light is 400 nm or less.

19. The electric wire formation method according to claim 1, wherein the partition wall includes a fluorine-containing organic molecule.

20. The electric wire formation method according to claim 1, further comprising subjecting the partition wall surface to plasma processing by using a fluorocarbon compound as a reactant gas.
